(19) United States
(12) Patent Application Publication
(10) Pub. No.: US 2005/0018290 A1
(43) Pub. Date: Jan. 27, 2005

(54) Colour filter means having optical activity under the influence of a polarized light

(76) Inventor: Ferenc Kiss, Budapest (HU)

Correspondence Address: WELSH & KATZ, LTD, 120 S RIVERSIDE PLAZA, 22ND FLOOR, CHICAGO, IL, 60606, US

(21) Appl. No.: 10/473,936

(22) PCT Filed: Apr. 5, 2002
(86) PCT No.: PCT/HU02/00028

(30) Foreign Application Priority Data
Apr. 5, 2001 (HU) P 0101422
Mar. 29, 2002 (HU) P 0202090

(51) Int. Cl. G02B 5/30; G02B 27/28

(52) U.S. Cl. 359/487

(57) ABSTRACT

The present invention relates to a colour filter means having optical activity under the influence of a polarized light for mounting frontwards of a natural or artificial imaging device (8). The colour filter means contains first optically active material (1) and first polarizer (2), both having optical axis aligned in the same direction and plane perpendicular to the optical axis. The colour filter means also contains a colour filter (5) dyed in its material. The first optically active material (1) can be optionally rotated around its optical axis and being in front of the imaging device (8). The core feature of the colour filter means is that from the aspect of sensing an unpolarized light passing therethrough keeps its colour or shows up a monochrome effect while the colour of a plane-polarized light is modified thereby in a pre-defined manner.

The present invention relates to colour filter means having optical activity under the influence of polarized light for use preferentially, but not exclusively in sunglasses and/or in imaging, image recording or image processing devices provided with optics.

At viewing or taking photos of different sceneries (living beings, objects, buildings, landscapes), or generally in such cases wherein an image of a certain scene is taken by means of a natural or an artificial imaging device (e.g. by means of the human eye or a camera and any other image collecting, image recording or image transmitting device), light carrying information on various details of the scene enters the imaging device concerned with different polarization state. For example, the light reflecting from reflection surfaces (such as water surfaces, leaves of plants, various glass surfaces, etc.) is (partially or fully, linearly) polarized. When direction of the propagation of light incident on vapour droplets and that of light scattered thereby are essentially perpendicular to each other, the diffuse sunlight is also polarized.

The polarization state (from now on the polarization) of a light beam can be modified up to an arbitrary extent as required by means of placing suitable optical elements into the path of the light beam considered.

The most well-known polarization modifying elements are those polarizers made of anisotropic materials (e.g. showing linear birefringence) with the shape of a plane, sheet, plate or layer that transmit only those components of incident light without loss which are of (linear) polarization parallel to a fixed direction (a direction perpendicular to this direction is referred to as the extinction direction of the polarizer) relative to the polarizer, while absorb partially or fully the other components of light that have different polarization from the one mentioned. A description of such a so-called dichroic polarizer can be found e.g. in Handbook of Optics (ISBN 0-07-047974-7, Vol. 11, pp. 327-330.) edited by Michael Bass.

It is the nature, known as optical activity, of certain transparent substances to rotate the polarization plane of a light beam passing therethrough to an extent in proportion to the thickness d of the substance, that is, to modify the polarization of incident light (for more details see e.g. A. Nussbaum and R. A. Phillips, Modern Optics for Engineers and Scientists, Chapter 14.6). This phenomenon was discovered by D. F. J. Arago in 1811, while a phenomenological explanation thereof was established by E. J. Fresnel in 1825 recognizing that within an optically active medium incident light of linear polarization splits into components of clockwise and counterclockwise circular polarization with a slight difference in propagation velocities thereof in the medium. As a result, a phase shift develops between the components on their way through the optically active medium, and the polarization plane of light obtained by unifying the components at a surface of departure from the medium is rotated through a certain angle relative to the polarization plane of incident light.

Many known substances show optical activity, among others different kinds of sugar solutions, turpentine, sodium chlorate (cubic), crystalline quartz (SiO₂, uniaxial), sodium nitrite (NaNO₃, biaxial), etc. In uni- and biaxial crystals the phenomenon can be most easily observed parallel to the optical axis. In case of uniaxial crystals the common linear birefringence does not emerge if propagation takes place along the optical axis. Some uniaxial crystals (among others quartz too), however, show a circular birefringence along this direction. In Nature the crystalline quartz has got both a dextrorotatory and a levorotatory modification, the crystalline shapes of which are reflections of each other. At the same time, silica glass (which is actually a supercooled liquid) is built up of SiO₂ molecules positioned randomly, hence silica glass does not affect at all the polarization plane of plane-polarized light passing therethrough.

There are numerous practical exploitations of the phenomenon of optical activity, e.g. by the investigation of clear and transparent optically active substances or in photoelastic apparatuses applied for stress analysis tests. The present phenomenon can be further used either for contrast enhancing and for reducing light reflection, as it is described in German Patent No. 2,649,842, or for preparing a sun visor device against strong sunshine for use in the cockpits of aircrafts in order to protect the eyes of the aviator, as it is thought in U.S. Pat. No. 5,115,341.

Furthermore, by observation of distant sceneries there is a need in many cases for enhancing certain parts of the scenery, i.e. for displaying or recording a certain detail with a stronger contrast. A possibility to fulfil this need is to take into account different polarization states of light coming from individual parts of the scenery. Such a so-called polarimetric image recorder should detect only the net linear polarization of the scenery, unpolarized or circularly polarized light should not be recorded thereby. U.S. Pat. No. 4,490,016 discusses a suchlike polarimetric image recorder that is based on the reorientation of anisotropic colour centres embedded in an alkali halide crystal reproducing the net polarization of the distant scenery due to exposure to an electromagnetic radiation of a given wavelength. However, the costs of production of the crystals used in such devices are relatively high.

A common disadvantage of the above mentioned solutions exploiting optical activity of a certain medium is that in case of usage hues of separate parts of the scenery cannot be modified independently of each other; this feature, however, is of great need in the field of various imaging techniques, such as e.g. inspection through a pair of sunglasses or methods for image recording and transmitting, e.g. photographing.

Modification of hues is achieved nowadays by using transparent colour filters dyed in material known per se, that are applied to lens of sunglasses or used in sunglasses, or arranged in front of camera optics. Such solutions, nevertheless, have got several disadvantages.

The usage of so-called coloured sunglasses obtained in this way, i.e. the observations made through them, in accordance with the characteristic, i.e. colour filtering properties of the colour filters used therein results that e.g. the colour receptor cells in the eye are becoming accustomed to sense all details of the scenery continually with a hue characteristic to the colour filter, which leads to a fading of strength of the stimulus transmission. Moreover, as the spectral sensitivity of colour receptors changes from colour to colour, it can happen that the intensity of certain details of the scenery perceived through the coloured pair of s sunglasses decreases to a huge extent relative to the actual intensity, which in certain cases can be disturbing. Furthermore, after such sunglasses have been taken off, the eye senses in its environment not the actual colour composition for a while and that can generate discomfort and an unusual sensation for the wearer.

Imaging devices provided with colour filter(s) also generate such images that are shifted in every detail towards the colour characteristic to the colour filter(s). For a different type of colour filters, namely for the so-called cross-over or half filters only half of the colour filter is dyed and its dying gradually changes along the diagonal of the colour filter into an undyed transparent surface. Two- or multi-coloured split colour filters are also used to tint certain parts of the image field. These colour filters are formed rotatably in front of the object-glass, therefore the part of the image to be coloured can be easily chosen. A common feature of the colour modifying means detailed here is that they show up all details of a certain image part in the colour chosen and in this regard they do not make an exception to other details in most cases of totally different colours entering into the area of the image part considered. For example, trees extending to the sky (to be coloured) in the landscape are necessarily going to come under the influence of the colour filter used, i.e. they are coloured which is undesirable in general. To eliminate the problem of becoming inappropriately tinted, split multi-coloured colour filters are also known. These, however, only diminish but do not solve the problem. Further details about the above described (cross-over) colour filters or series of colour filters can be found e.g. in a catalogue (published in 1998, p. 369, in Hungarian) of Hama Corporation offering photographical means and articles.

German Patent No. 2,650,500 teaches a colour filtering apparatus for separating a single component (a laser line) of a laser beam composed of several components each of a discrete wavelength. The apparatus contains a crystal made of e.g. quartz having an optical activity proportional to the thickness thereof and a polarization specific optical means, e.g. a polarization splitting cube realized as a Nicol prism, arranged after each other. A laser beam in particular composed of two components of different wavelengths and hence of different colours introduced into the apparatus is split by the quartz crystal into monochromatic beams with polarization states perpendicular to each other. By a proper adjustment of the polarization specific optical means arranged at the back of the crystal either of the monochromatic beams can be totally filtered out. As a result, the remaining beam will be of a single well-defined colour. A disadvantage of the colour filtering apparatus of this type is that due to the given thickness of the quartz crystal included therein, it can be used for filtering, splitting and, by the way, colour modification for only a laser beam of definite composition (in wavelength).

As a summary we conclude that on the one hand the action of known dichroic polarizers is identical in a broad range of wavelengths and hence is practically independent of the colour of incident light, while on the other hand the action of known colour filters dyed in material is in general independent of the polarization of incident light. Consequently, the greatest deficiency of devices presently used is that they are not suitable for modifying the colour of individual parts of an image taken of a scenery with taking into consideration the polarization direction of light entering into the imaging device from the respective parts of the scenery.

The object of the present invention is to eliminate the above deficiencies of the known devices, i.e. to develop a colour filter means that modifies the colour of light coming from a scenery and traversing the means taking into consideration the polarization of incident light and/or angular positions of the optical elements constituting the means in such a way that, from the aspect of sensing, unpolarized light keeps its colour or shows up a monochrome effect, while polarized light goes through a colour modification desired.

Our investigations led us to the conclusion that the aimed object of the present invention can be fulfilled by a colour filter means containing an optially active material, a polarizer and a colour filter dyed in its material, wherein the light beam entering the colour filter means reaches and passes through the optically active material first and strikes the polarizer only afterwards. In such a colour filter means the colour filter dyed in its material can be placed in the path of the light beam arbitrarily, with no constraints on its position. Furthermore, the optical elements mentioned above can be doubled, i.e. they can be applied twice after each other in the same order. In one embodiment of the colour filter means at issue at first an (second) optically active material, then a (second) polarizer followed by an (first) optically active material and finally a (first) polarizer are arranged in the path of the incoming light beam. The optically active materials can owe identical or different optical activities. The polarizers also can be identical or different in properties. From the latter embodiment of the colour filter means at issue, the colour filler dyed in its material can be even dropped out

In view of the above, the present invention provides a colour filter means containing an optically active material and a polarizer both having an optical axis pointing into the same direction and arranged in planes perpendicular to the optical axis, characterized in that the optically active material is situated in front of the polarizer and can be optionally rotated around its optical axis, the polarizer is situated in front of the imaging device and can be optionally rotated around its optical axis, and the colour filter means also has a colour filter made of a dyed material. The first polarizer preferably is a linear polarizer or an elliptic polarizer or a circular polarizer.

A possible further embodiment of the colour filter means according to the invention also contains a second optically active material and a second polarizer, both being optionally rotatable around their respective optical axes, wherein the second optically active material is arranged in front of the second polarizer and the second polarizer is aranged in front of the optically active material. Here, the second polarizer preferably is a linear polarizer or an elliptic polarizer, wherein the ratio of major to minor axis of the ellipse swept by the electric field strength (vector E) of light beam traversing the polarizer approaches infinity.

Furthermore, the optically active materials are preferably made of uniaxial crystalline quartz or rutile or zirconium or biaxial mica or cordierite or sodium nitrite or a colourless, transparent optically active plastic material of uniform uniaxial internal stress that conserves a permanent deformation having caused by an external force in its molecular structure. The polarizers are preferably made of a polarizing plate known as H-plate or a polarizing plate of tourmaline or a sheet of polarized polycarbonate or a sheet of polarized CR-39 hard-resin, while the colour filter Is preferably made of a filter element active in the spectral range of the visible light and/or of an ultraviolet filter element that filters out ultraviolet rays of at most 396 nm in wavelength.

In a possible further embodiment of the colour filter means according to the present invention the colour filter and further the optically active materials and the polarizers being optionally rotatable around their respective optical axes are preferably arranged in and guided by filter supporting rings. Furthermore, the above embodiment of the colour filter means also has a connecting ring enabling the connection with the filter supporting rings and the mounting on the imaging device.

The colour filter means according to the present invention are preferably used with a pair of sunglasses or with imaging devices and/or image recording devices and/or image transmitting devices.

The invention and its operating principle will be explained via particular embodiments in detail with reference to the accompanied drawings, wherein

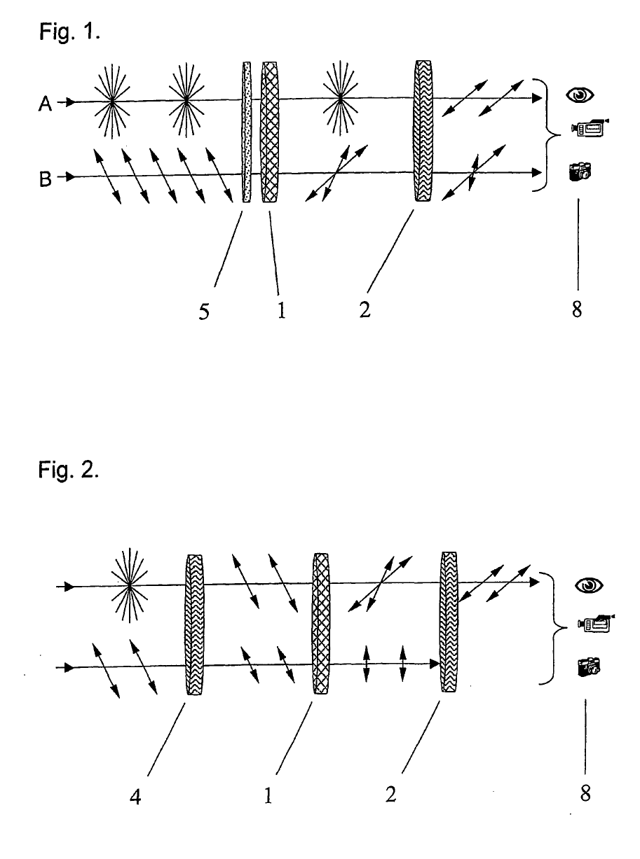

FIG. 1 shows a diagrammatic sketch of the most general embodiment of the colour filter means having optical activity under the influence of a polarzed light according to the present invention;

FIG. 2 is a diagrammatic sketch of an another embodiment of the colour filter means;

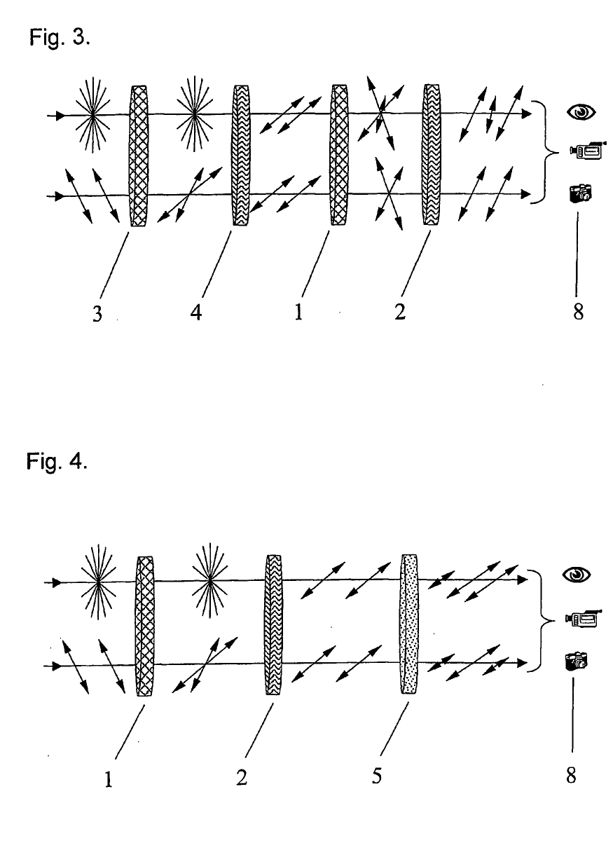

FIG. 3 is a diagrammatic sketch of a further embodiment of the colour filter means;

FIG. 4 is a diagrammatic sketch of yet another embodiment of the colour filter means;

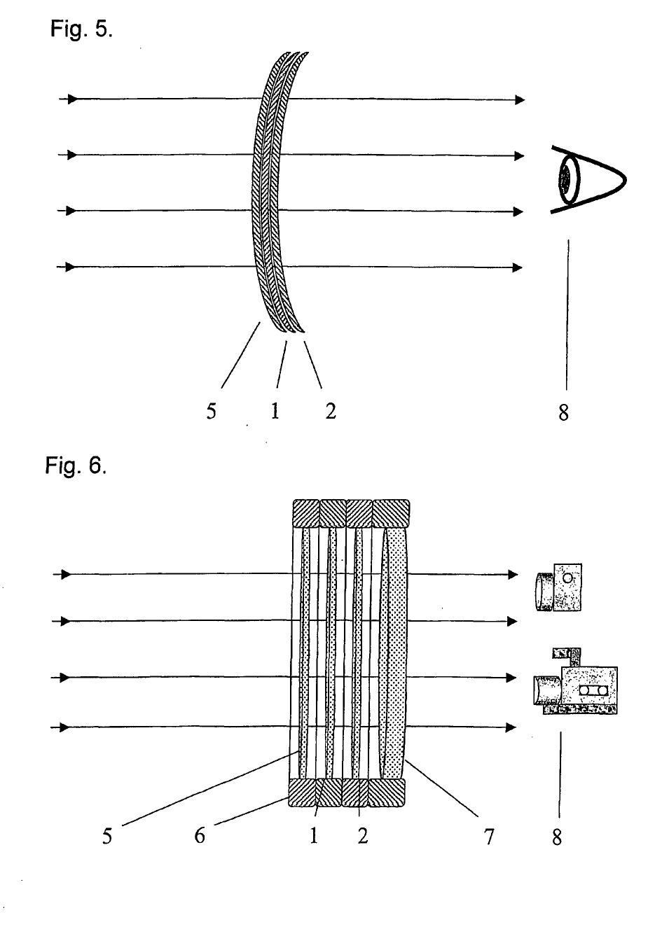

FIG. 5 represents a preferred practical embodiment of the colour filter means shown in FIG. 1; and finally

FIG. 6 illustrates a preferred further practical embodiment of the colour filter means shown in FIG. 1.

In the Figures the arrows of different directions and sizes refer to polarization states and correspondent amplitudes of a light beam in a given point, Accordingly, a single arrow symbolizes linearly polarized light, while arrows crossing each other denote light having components of various polarizations.

The term “optically active material” refers to a substance that rotates linearly polarized incident light to various extent depending on wavelengths of its components, however, its other optical properties influence no interfering effects on the optical operation thereof being important from the aspect of the present invention.

FIG. 1 shows the most general diagrammatic sketch of the colour filter means according to the invention. It comprises in the direction of propagation of light beams A, B from their source(s) towards an imaging device 8 a first optically active material 1 and a first polarizer 2 both arranged in front of the imaging device 8 that is also placed in the path of the light beams A, B. The imaging device 8 can be either a natural imaging device (e.g. human eye) or an artificial one (e.g. a camera or a camera optics). The colour filter means further contains a colour filter 5 dyed in its material that is arranged in the path of the light beams A, B somewhere in front of the imaging device 8. According to the sketch of FIG. 1, the colour filter 5 dyed in its material is arranged in particular in front of the first optically active material 1, however, it can be placed either in between the first optically active material 1 and the first polarizer 2 or at the back of the first polarizer 2.

The first optically active material 1, the first polarizer 2 and the colour filter 5 dyed in its material can be of any shape, however, from the aspect of practical applicability they take preferably the shape of a circular plane, sheet or layer. The planes of greatest extension of the first optically active material 1 and of the first polarizer 2, i.e. their faces are essentially parallel to each other and approximately perpendicular to the optical axis of the imaging device 8. The colour filter 5 dyed in its material can occupy any position.

The optical axis of the first optically active material 1 points into such a direction that plane-polarized light beam B be rotated by the first optically active material 1 through different angles depending on the magnitude of its wavelength. The first polarizer 2 is a linear or an elliptic or a circular polarizer.

The first optically active material 1 used in the colour filter means according to the invention is made preferentially of uniaxial crystalline quartz, rutile, zirconium or biaxial mica, cordierite, sodium nitrite or a cooled and at ambient temperature solid, colourless, transparent optically active plastic material of uniform uniaxial internal stress, wherein the plastic material further has optical properties characteristic to optically active substances and essential for the invention. From this point of view plexiglass or cellophane (in thickness d of 0.02 mm, in several layers) having subjected to a uniform draw or tension during cooling can be advantageously used. Certain plastic materials produced by extrusion or injection moulding techniques or glasses subjected to a quenching process show the optical properties being of importance for the present invention even in the case of no further external mechanical influence thereon, that is, they are optically active. Their optical activity is due to the state of stress “frozen up” during the production (or quenching) process.

In natural state glassy amorphous substances and transparent polymers (e.g. plexiglass) are isotropic and do not show optical activity, however, as a consequence of changes in their microstructure due to a mechanical load they become optically active. Furthermore, e.g. those organic substances are also optically active, the molecules of which contain asymmetric carbon atoms with a valence being coupled to four different atomic groups. These substances can be used also advantageously in the colour filter means according to the present invention.

The material of the first polarizer 2 used in the colour filter means according to the present invention is comprised preferably of the material of polarization filters or layers known per se, e.g. polarized polycarbonate, polarized CR-39 hard-resin or tourmaline. Another useful polarizer is the so-called H-plate (or H-polaroid) prepared by forming a plate of long-chained molecules by drawing polyvinyl alcohol, bonding the thus drawn plate to a cleaned plate of cellulose acetate butyrate to assure the retention of shape of the former and immersing the thus obtained composite plate into an iodine solution. Iodine diffuses into the plate of polyvinyl alcohol and creates complexes at the bends of the long chains. A major portion of visible light having polarization parallel to the length of the chains is absorbed by the iodine complexes, while light of polarization perpendicular to the chains is transmitted.

The colour filter 5 dyed in its material is known per se, it effects filtering in the spectral range of visible light and/or of ultraviolet rays of at most 396 nm in wavelength.

The operating principle of the colour filter means according to the present invention is the following.

Natural light is a result of spontaneous and random light emission of atoms. The light emitted by individual atoms is polarized, however, in natural light vectors E and B oscillating in different directions are present in equal amount. If natural light, i.e. the fully unpolarized light beam A reaches the first optically active material 1, then any component thereof having a definite wavelength (and hence a colour) chosen arbitrarily has got diverse polarization directions and respective amplitudes equal in magnitude. As all the components of the incident light beam A are attenuated to the same extent by the first polarizer 2 independently of the presence of the first optically active material 1, the unpolarized light beam A becomes polarized by the colour filter means according to the invention independently of its colour.

On the contrary, the incident light beam B of linear (or circular) polarization is attenuated by the colour filter means according to the invention to an extent dependent on the wavelength thereof, since the first optically active material 1 rotates the plane of polarization of light passing therethrough to an extent (i.e. through an angle) dependent on the wavelength. If the optically active material 1 is prepared as e.g. a plate of 1 mm in thickness cut from uniaxial crystalline quartz, the polarization plane of e.g. an ultraviolet light beam is rotated through an angle of 50°, while that of a red light beam is rotated through only an angle of 15° by it.

The change in direction of polarization is, however, accompanied by modification of the attenuation induced by the first polarizer 2, which results in a preset modification of the colour of the plane-polarized light beam B traversing the colour filter means according to the present invention, as a portion of the light beam B is filtered out by the colour filter means.

FIG. 2 represents a diagrammatic sketch of a possible further embodiment of the colour filter means according to the invention, which besides the first optically active material 1 and the first polarizer 2 illustrated in FIG. 1, in this case in lieu of the colour filter 5 dyed in its material, also contains a second polarizer 4 arranged in front of the first optically active material 1 in the path of light beams A, B. This embodiment, however, is already known from International Publication No. WO 00/19251. The second polarizer 4 can be of any shape, however, it takes preferably the form of a disk-shaped plane, faces of which are essentially parallel to the faces of the first optically active material 1 and of the first polarizer 2. Function of the second polarizer 4 is to generate (linearly or elliptically) plane-polarized light from ordinary light incident thereon. The such generated light suffers colour modification during traversing optical elements (i.e. first optically active material 1 and first polarizer 2) arranged at the back of the second polarizer 4. Therefore, polarizer 4 is a linear polarizer or an elliptical one, wherein the ratio of major to minor axis of the ellipse swept by the electric field strength (vector E) of light traversing the polarizer approaches infinity. The greater this. ratio, the more linearly polarized is the light leaving the second polarizer 4. Suitable materials for the second polarizer 4 are the materials outlined in connection with the first polarizer 2, i.e. the second polarizer 4 can be prepared from an H-plate, tourmaline, polarized polycarbonate or polarized CR-39 hard-resin.

If individual optical elements constituting the embodiment shown in FIG. 2 are rotated relative to each other along the optical axis, the colour of the whole imaging area can be arbitrarily altered. Hence, with using the present embodiment, various colour modification possibilities can be obtained even without continual manual exchange of traditional colour filters, purely by means of the application of an universal (monochrome) colour filter of variable colour (as the second polarizer 4).

FIG. 3 illustrates a diagrammatic sketch of a possible further embodiment of the colour filter means according to the invention; it is similar to the embodiment of FIG. 1, the only difference relative to that is that it contains the combination of optically active material and polarizer arranged twice after each other. Accordingly, the present embodiment contains a second optically active material 3, a second polarizer 4, a first optically active material 1 and a first polarizer 2 in this order viewed in the path of propagation of light. The optical elements mentioned here can be of any shape, however, they preferably take the form of diskshaped planes, and their materials can be chosen from the proper materials introduced earlier.

In case of the embodiment shown in FIG. 3 of the colour filter means according to the invention an unpolarized light beam striking the colour filter means and passing therethrough looses its initial colour composition viewed from the direction of the imaging device 8, while a light beam of linear or elliptical polarization entering the colour filter means can have a different colour relative to the unpolarized light. This means that light beams coming from various parts of a scenery in different polarizations (i.e. being unpolarized or plane-polarized) reach the imaging device 8 in different colours, that is, respective parts of the scenery can be seen in different colours.

FIG. 4 represents a modified variant of the embodiment shown in FIG. 1, wherein the colour filter 5 dyed in its material is arranged between the first polarizer 2 and the imaging device 8.

Based on the results achieved up to the present time in the fields of production and development of sunglasses, an endeavour of developers can be well apprehended according to which besides absorbing/filtering out detrimental ultraviolet radiation, sunglasses should reduce not only the visible spectral range in intensity, but via filtering out or intensifying certain colours they should also improve a scenery into such a scenery a hue of that is pleasant for the eye.

Accordingly, FIG. 5 illustrates a possible practical embodiment of the diagrammatic sketch shown in FIG. 1, in particular for using in a pair of sunglasses. In case of the present embodiment the colour filter 5 dyed in its material, the first optically active material 1 and the first polarizer 2 are applied to a substrate (not shown in the figures), e.g. to a spectacle lens. The optical elements concerned are produced e.g. in such a way that by means of per se known techniques a layered structure is formed on the substrate from substances of appropriate properties. Optionally, the required optical elements are attached to each other in the order illustrated in FIG. 5 e.g. by adhesive bonding, and the thus obtained single combined optical element is mounted then with detachable joints (e.g. by using clamps) or with non-detachable joints (e.g. by adhesive bonding or moulding) onto the substrate or optionally on the sunglasses' frame. Optical elements used for the colour filter means according to the present invention can be prepared relatively easily by machine tools of present days.

Sceneries, i.e. objects or figures of Nature viewed through the thus obtained pair of sunglasses are tinted in different manner depending on their positions occupied in the scenery and on their material. Without changing contours, e.g. the colouring of blue sky into a darker tone, the overcolouring of the sea or of any other glossy water surfaces, the overcolouring of glass surfaces and of various solid wet surfaces (such as macadam pavements) and furthermore the colour filtering of light threading on the leaves of plants or the monochrome filtering of colours of Nature, except for light become polarized in different directions, that can have any colour differing from the prevailing monochrome colour, can be reached just to mention only a few examples without completeness. All this means that the displeasing feature of overcolouring into a certain colour characteristic to the presently manufactured sunglasses does not appear for sunglasses provided with colour filter means according to the present invention.

Furthermore, it is preferred to manufacture series of sunglasses with variation in colour.

As it has been already mentioned, another field of application of colour filter means according to the invention is photography and various image collecting, image recording and image transmitting devices.

Accordingly, FIG. 6 represents a possible further practical embodiment of the diagrammatic sketch shown in FIG. 1, in particular for using together with cameras or video camera recorders. In such an embodiment the colour filter 5 dyed in its material, the first optically active material 1, the first polarizer 2 and if used the second optically active material 3 and the second polarizer 4 are arranged in shaped filter supporting rings 6 that can be mounted onto the imaging device 8. Function of the filter supporting rings 6 is to assure rotatability around the optical axis of the optical elements concerned and to support and/or guide them. Filter supporting rings 6 are connected to each other and finally to a connecting ring 7 in a way per se known, wherein the connecting ring 7 can be coupled to the imaging device 8 through a detachable joint, e.g. with a bayonet-joint or a threaded form joint. In this manner the colour filter means according to the invention can be easily and quickly fastened in front of the optics of the imaging device 8.

Besides the above presented embodiment, series of the colour filtering means with non-detachable joint can be also manufactured, as it was described earlier in connection with the embodiments suitable for sunglasses.

The axis of rotation of the parts of the colour filter means optionally prepared as being rotatable should be considered to be perpendicular to the faces of the parts, essentially aligned with a direction determined by the optical axis of the imaging device 8, i.e. approximately parallel to incident light beams A, B.

After having rotated around the optical axis, the optically active materials 1, 3 and the polarizers 2, 4 can stand in various angles relative to each other. Hence, if polarized light beams traverse the colour filter means according to the invention in different directions, a colour modification to an arbitrary extent can be obtained.

In case of applications in camera recorders first polarizer 2 is a circular polarizer. In this way the possibility of an incorrect photometering and an erroneous exposition can be automatically eliminated by the usage of the colour filter means according to the invention for motionpicture cameras and for certain reflex cameras provided with a polarization-based internal photometric system. This holds e.g. to video camcorders that carry on autofocus measurements, as in these devices photometering takes place through the object-glass. Second polarizer 4 is preferably a linear polarizer, however, it might be an elliptic one, too.

In photography and by other image collecting, image recording and image transmitting methods enhancement or suppression of various hues by means of colour filters has to be applied often. This defect can be also easily eliminated for sceneries wherein for one reason or another a plane-polarized light coming from the scenery, such as the gloss of sky or a water surface, or the gloss of a glass or a plastic surface, etc. is to be modified in colour by means of the colour filter means according to the invention. Contours of individual details of the scenery are not mixed up in colour, which is a qualitative progress over colour filter means commonly used nowadays. As the practical embodiments, that can be also mounted on the imaging devices, of the colour filter means according to the present invention are configured with a rotatable design, polarized light or any gloss can be changed into a colour chosen arbitrarily by the application of the colour filter means.

1. A colour filter means having optical activity under the influence of a polarized light for mounting in front of a natural or artificial imaging device (8), wherein the colour filter means contains an optically active material (1) and a polarizer (2), both having an optical axis pointing into the same direction and arranged in planes perpendicular to the optical axis, characterized in that the optically active material (1) is situated in front of the polarizer (2) and can be optionally rotated around its optical axis, the polarizer (2) is situated in front of the imaging device (8) and can be optionally rotated around its optical axis, and the colour filter means also has a colour filter (5) made of a dyed material.

2. The colour filter means according to claim 1, characterized in that the polarizer (2) is a linear polarizer or an elliptic polarizer or a circular polarizer.

3. The colour filter means according to claim 1, characterized in that it also contains a second optically active material (3) and a second polarizer (4), both being optionally rotatable around their respective optical axes, wherein the second optically active material (3) is arranged in front of the second polarizer (4) and the second polarizer (4) is arranged in front of the optically active material (1).

4. The colour filter means according to claim 3, characterized in that the second polarizer (4) is a linear polarizer or an elliptic polarizer, wherein the ratio of major to minor axis of the ellipse swept by the electric field strength (vector E) of light beam (A, B) traversing the polarizer approaches infinity.

5. The colour filter means according to claim 1, characterized in that the optically active materials (1, 3) are made of uniaxial crystalline quartz or rutile or zirconium or biaxial mica or cordierite or sodium nitrite or a colourless, transparent optically active plastic material of uniform uniaxial internal stress that conserves a permanent deformation having caused by an external force in its molecular structure.

6. The colour filter means according to claim 1, characterized in that the polarizers (2, 4) are made of a polarizing plate known as H-plate or a polarizing plate of tourmaline or a sheet of polarized polycarbonate or a sheet of polarized CR-39 hard-resin.

7. The colour filter means according to claim 1, characterized in that the colour filter (5) is made of a filter element active in the spectral range of the visible light and/or of an ultraviolet filter element that filters out ultraviolet rays of at most 396 nm in wavelength.

8. The colour filter means according to claim 1, characterized in that the colour filter (5) and further the optically active materials (1, 3) and the polarizers (2, 4) being optionally rotatable around their respective optical axes are arranged in and guided by filter supporting rings (6).

9. The colour filter means according to claim 8, characterized in that it has a connecting ring (7) enabling the connection with the filter supporting rings (6) and the mounting on the imaging device (8).

10. The colour filter means according to claim 1, characterized in that the imaging device (8) is a natural imaging device.

11. The colour filter means according to claim 1, characterized in that the imaging device (8) is an artificial imaging device.

12. Use of the colour filter means according to claim 1 with a pair of sunglasses.

13. Use of the colour filter means according to claim 1 with imaging devices and/or image recording devices and/or image transmitting devices.
